(19) United States
(12) Patent Application Publication
(10) Pub. No.: US 2016/0353518 A1
(43) Pub. Date: Dec. 1, 2016

(54) Ultrasonic Mesh Network System

(71) Applicants: AT&T Mobility II LLC, Atlanta, GA (US); AT&T Intellectual Property I, L.P., Atlanta, GA (US)

(72) Inventors: Sheldon Kent Meredith, Roswell, GA (US); Brandon B. Hilliard, Woodstock, GA (US); William Cottrill, Canton, GA (US)

(73) Assignees: AT&T INTELLECTUAL PROPERTY I, L.P., Atlanta, GA (US); AT&T MOBILITY II LLC, Atlanta, GA (US)

(21) Appl. No.: 14/725,389

(22) Filed: May 29, 2015

(51) Int. Cl. H04W 84/18; H04B 11/00

(52) U.S. Cl. CPC H04W 84/18; H04B 11/00

(57) ABSTRACT

Concepts and technologies are disclosed herein for an ultrasonic mesh network system. According to one aspect, an ultrasonic mesh network system can include a plurality of nodes deployed within an environment. The plurality of nodes can include first and second nodes. The first node can include a first ultrasonic transceiver and a sensor. The second node can include a second ultrasonic transceiver. The first node can detect, via the sensor, one or more characteristics of the environment. In response, the first node can generate a message that includes the characteristic(s) of the environment. The first node also can transmit, via the first ultrasonic transceiver, the message into the environment. The second node can receive, via the second ultrasonic transceiver, the message from the first ultrasonic transceiver on the ultrasonic frequency. The second node can retransmit, via the second ultrasonic transceiver, the message received from the first ultrasonic transceiver.

### BACKGROUND

The Internet of Things (“IoT”) is a concept of making physical objects, collectively “things,” network addressable to facilitate interconnectivity for the exchange of data. The IoT community is focused on interconnecting IoT devices using BLUETOOTH and WI-FI technologies. To mitigate interference between IoT devices, such as from next door neighbors, BLUETOOTH low energy (“LE”) is the current front running solution. IoT devices can share information with each other or with the “outside world” (e.g., Internet) via a hub device or router. Radio transmitters and receivers are relatively expensive. For this reason, having multiple IoT devices that utilize wireless transmitter/receiver components in a home or business environment implies a potentially significant overall investment, which poses a real stumbling block for the future of the IoT concept due to the slow adoption rate. The lower the cost associated with IoT interconnectivity components becomes, the more IoT devices users and businesses can afford to interconnect.

### SUMMARY

Concepts and technologies are disclosed herein for an ultrasonic mesh network system. According to one aspect of the concepts and technologies disclosed herein, an ultrasonic mesh network system can include a plurality of nodes deployed within an environment. The plurality of nodes can be Internet of Things (“IoT”) devices. The plurality of nodes can include a first node and a second node. The first node can include a first ultrasonic transceiver and a sensor. The second node can include a second ultrasonic transceiver. The first node can detect, via the sensor, one or more characteristics of the environment. In response, the first node can generate a message that includes the characteristic(s) of the environment. The first node also can transmit, via the first ultrasonic transceiver, the message into the environment. The second node can receive, via the second ultrasonic transceiver, the message from the first ultrasonic transceiver on the ultrasonic frequency. The second node can retransmit, via the second ultrasonic transceiver, the message received from the first ultrasonic transceiver.

In some embodiments, the plurality of nodes can include a third node. The third node can include a third ultrasonic transceiver. The third node can receive, via the third ultrasonic frequency, the message from the first ultrasonic transceiver on the ultrasonic frequency. The third node can retransmit, via the third ultrasonic transceiver, the message received from the first ultrasonic transceiver on the ultrasonic frequency. The third node can receive, via the third ultrasonic transceiver, the message from the second ultrasonic transceiver. In response to receiving the message from the second transceiver, the third node can determine that the message was already received from the first ultrasonic transceiver and can ignore the message received from the second ultrasonic transceiver.

In some embodiments, the first node can initialize a retransmission counter. The retransmission counter can be used to track the number of times the message is retransmitted by any node of the plurality of nodes. The retransmission counter can be associated with a maximum retransmission setting. In response to receiving the message, the second node can increment the retransmission counter by one and can determine whether the retransmission counter exceeds a maximum retransmission setting. If the retransmission counter does not exceed the maximum retransmission setting, the second node can retransmit the message. If, however, the retransmission counter exceeds the maximum retransmission setting, the second node can determine not to retransmit the message. Other nodes of the plurality of nodes can make similar determinations.

In some embodiments, the ultrasonic mesh network system can include a network interface. The network interface can receive the message from the first ultrasonic transceiver, the second ultrasonic transceiver, both, or any other of the plurality of nodes. In response, the network interface can transmit the message to a network through which the message can be provided to one or more services that can utilize the characteristic(s) of the environment included in the message to perform one or more operations.

In some embodiments, the second node can retransmit the message on the same ultrasonic frequency on which the message was received from the first ultrasonic transceiver. In some other embodiments, the second node can retransmit the message on a different ultrasonic frequency from the frequency on which the message was received from the ultrasonic transceiver.

According to one aspect of the concepts and technologies disclosed herein, an ultrasonic mesh network node is deployed within an environment that includes a plurality of ultrasonic mesh network nodes. The ultrasonic mesh network node can include a sensor, an ultrasonic transceiver, a processor, and a memory. The memory can store instructions that, when executed by the processor, cause the ultrasonic mesh network node to perform operations. In particular, the ultrasonic mesh network node can cause the sensor to detect one or more characteristics of the environment. The ultrasonic mesh network node can generate a message that includes the characteristic(s) of the environment. The ultrasonic mesh network node can cause the ultrasonic transceiver to transmit the message into the environment.

In some embodiments, the ultrasonic mesh network node also can receive the message from a further ultrasonic mesh network node of the plurality of ultrasonic mesh network nodes. The ultrasonic mesh network node also can determine that the message received from the further ultrasonic mesh network node is the same as the message that the ultrasonic transceiver transmitted into the environment. In response to determining that the message received from the further ultrasonic mesh network node is the same as the message that the ultrasonic transceiver transmitted into the environment, the ultrasonic mesh network node can ignore the message received from the further ultrasonic mesh network node.

In some embodiments, the ultrasonic mesh network node can receive a further message from a further ultrasonic mesh network node of the plurality of ultrasonic mesh network nodes. The ultrasonic mesh network node also can increment a retransmission counter by one in response to receiving the further message. The ultrasonic mesh network node also can determine that the retransmission counter does not exceed a maximum retransmission setting. The ultrasonic mesh network node also can retransmit the further message into the environment.

In some embodiments, the ultrasonic mesh network node can receive a further message from a further ultrasonic mesh network node of the plurality of ultrasonic mesh network nodes. The ultrasonic mesh network node can increment a retransmission counter by one in response to receiving the further message. The ultrasonic mesh network node can determine that the retransmission counter exceeds a maximum retransmission setting. The ultrasonic mesh network node can determine not to retransmit the further message into the environment.

In some embodiments, the ultrasonic mesh network node can cause the ultrasonic transceiver to transmit the message to a network interface. The network interface can transmit the message on to a network through which the message can be received by one or more services, which can perform one or more operations utilizing the characteristic(s) of the environment included in the message.

In some embodiments, the ultrasonic mesh network node also can receive a further message from a further ultrasonic mesh network node of the plurality of ultrasonic mesh network nodes on a first ultrasonic frequency. The ultrasonic mesh network node also can receive the message on an ultrasonic frequency and can retransmit the further message into the environment on a different ultrasonic frequency.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating aspects of an illustrative operating environment for various concepts disclosed herein.

FIG. 2 is a diagram illustrating an ultrasonic mesh network, according to an illustrative embodiment.

FIG. 3 is a flow diagram illustrating aspects of a method for transmitting a message through an ultrasonic mesh network system, according to an illustrative embodiment.

FIGS. 4A-4B are flow diagrams illustrating aspects of another method for transmitting a message through an ultrasonic mesh network system, according to an illustrative embodiment.

FIG. 5 is a flow diagram illustrating aspects of a method for transmitting a message through an ultrasonic mesh network system to a network interface, according to an illustrative embodiment.

FIG. 6 is a block diagram illustrating an example computer system capable of implementing aspects of the embodiments presented herein.

FIG. 7 schematically illustrates a network, according to an illustrative embodiment.

FIG. 8 is a block diagram illustrating an example mobile device and components thereof, according to an illustrative embodiment.

### DETAILED DESCRIPTION

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer system, including hand-held devices, mobile devices, wireless devices, multiprocessor systems, distributed computing systems, microprocessor-based or programmable consumer electronics, minicomputers, mainframe computers, routers, switches, other computing devices described herein, and the like.

In the following detailed description, references are made to the accompanying drawings that form a part hereof, and in which are shown by way of illustration specific embodiments or examples. Referring now to the drawings, in which like numerals represent like elements throughout the several figures, example aspects of an ultrasonic mesh network system will be presented.

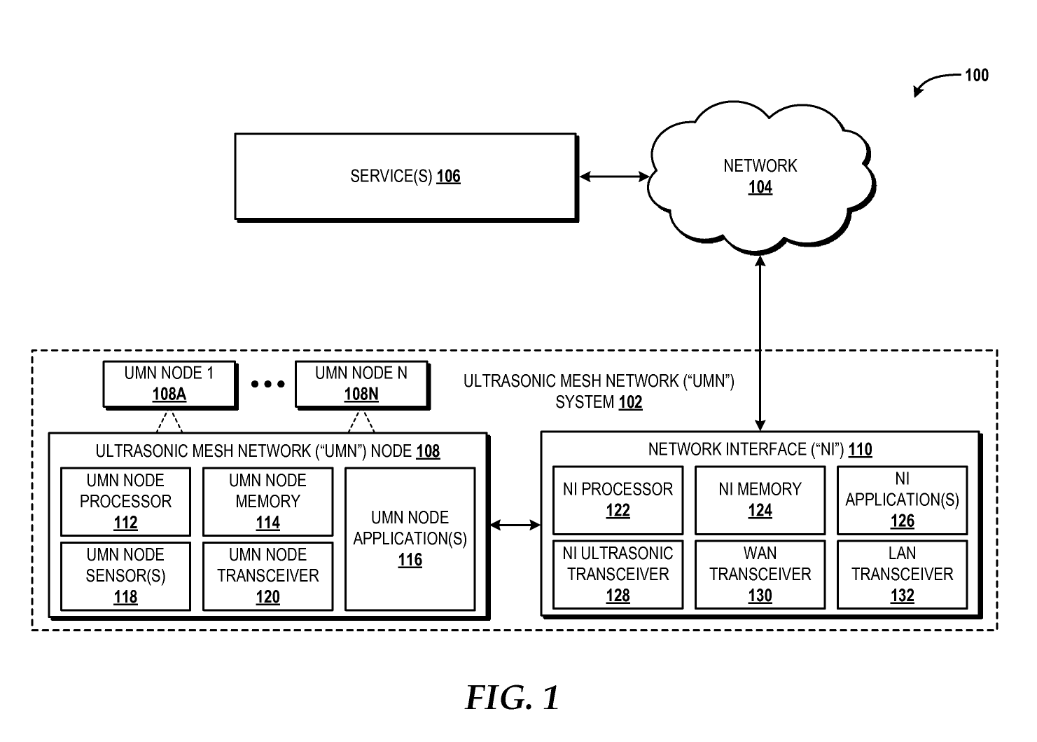

Referring now to FIG. 1, aspects of an operating environment 100 in which various embodiments presented herein may be implemented will be described, according to an illustrative embodiment. The illustrated operating environment 100 includes an ultrasonic mesh network (“UMN”) system 102, a network 104, and one or more services 106. The illustrated ultrasonic mesh network system 102 includes a plurality of UMN nodes 108A-108N that form a mesh network interconnected via ultrasonic acoustic communications. The plurality of UMN nodes 108A-108N can be deployed in various locations within the environment. The environment can include any indoor environment, outdoor environment, or a combination thereof. Some example environments include, but are not limited to, buildings, single family homes, duplexes, triplexes, apartments, condominiums, stadiums, coliseums, theaters, tents, port-a-potties, stages, alleyways, subway tunnels, sewers, vehicle interiors, and the like. The plurality of UMN nodes 108A-108N can relay information to a network interface 110 of the ultrasonic mesh network system 102 through the environment. The network interface 110 can provide the information relayed across the mesh network to the service(s) 106 via the network 104. In this manner, the ultrasonic mesh network system 102 can facilitate the transmission of information across the environment utilizing ultrasonic acoustic communications that, by nature, are short-lived and do not travel far nor well, especially through solid objects such as walls in an indoor environment. Moreover, the ultrasonic mesh network system 102 eliminates the need for expensive receiver and transmitter components, such as BLUETOOTH, BLUETOOTH low energy, WI-FI, or the like.

Each of the plurality of UMN nodes 108A-108N can transmit an acoustic waveform. The acoustic waveform can be a chirp waveform, a coded waveform, or other waveform. The period, frequency, and amplitude of the acoustic waveforms can be set for a given environment and might be modified dynamically to account for changes within the environment (e.g., the addition or removal of one or more UMN nodes 108 from the ultrasonic mesh network system 102). In accordance with embodiments disclosed herein, each acoustic waveform generated and transmitted by the plurality of UMN nodes 108A-108N includes one or more frequencies above human-audible sound, and more particularly, includes frequencies above 20,000 Hertz (“Hz”). Each of the plurality of UMN nodes 108A-108N also can listen for an echo to determine the distance to the closest object off of which the waveform is bouncing. Waveform analysis can detect multiple bounces similar to what can be detected in delay equalization in radio transceivers.

The UMN nodes 108 can measure movement, infrared signature, smoke, CO2, temperature, water, pressure, or anything else (collectively “characteristics”) in an environment. The UMN nodes 108 could be plugged into a wall outlet or could be battery operated and placed anywhere within the environment. A given set of UMN nodes 108 may have identifiers such as A, B, C, D, and E, or the like. Historical information for information exchanges among a given set of UMN nodes 108 can be used for pattern trending for the purpose of detecting outlier behavior.

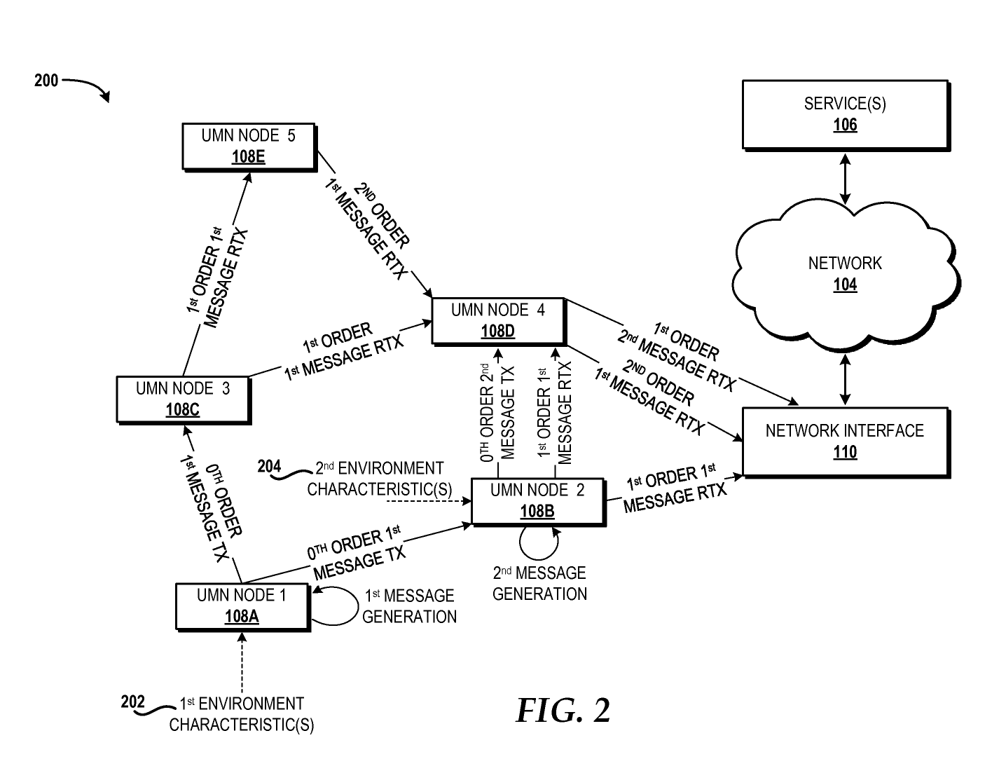

The illustrated example UMN node 108 includes a UMN node processor 112, a UMN node memory 114, one or more UMN node applications 116, one or more UMN node sensors 118, and a UMN node transceiver 120. The UMN node processor 112 can include one or more processing units configured to process data, execute computer-executable instructions of one or more application programs such as the UMN node application(s) 116 stored in the UMN node memory 114, and communicate with other components of the UMN node 108 in order to perform various operations described herein, such as the operations illustrated and described herein with reference to FIGS. 2-5. The UMN node processor 112 may be a standard central processor that performs arithmetic and logical operations, a more specific purpose programmable logic controller (“PLC”), a programmable gate array, a system-on-a-chip, or other type of processor known to those skilled in the art and suitable for controlling the operation of the server computer. Processing units are generally known, and therefore the functionality of processing units is not described in further detail herein.

The UMN node memory 114 can include, but is not limited to, processor registers, processor cache, random access memory (“RAM”), other volatile and non-volatile memory devices, semi-permanent or permanent memory types; for example, tape-based media, optical media, flash media, hard disks, combinations thereof, and the like. While the UMN node memory 114 is illustrated as residing proximate to the UMN node processor 112, it should be understood that the UMN node memory 114 may be a remotely accessed storage system, for example, a server and/or database on a communications network, a remote hard disk drive, a removable storage medium, a database, a server, an optical media writer, combinations thereof, or the like. Memory units are generally known, and therefore the functionality of memory units is not described in further detail herein.

In the claims, the phrase “computer storage medium” and variations thereof is intended to encompass devices such as the UMN node memory 114 and other memory components disclosed herein and does not include waves or signals per se and/or communication media such as computer-readable instructions, data structures, program modules, or other data in a modulated data signal such as a carrier wave or other transport mechanism and includes any delivery media.

The UMN node sensor(s) 118 can include any sensor type or combination of sensor types utilizing any known sensor technology that is capable of detecting one or more characteristics of the environment in which the UMN system 102 is deployed. The UMN node sensor(s) 118, for example, might include a smoke detector, a motion detector, a fall detector, a flood detector, an alarm sensor, an environment control sensor, a carbon monoxide detector, a medication dispenser sensor, an entry/exit detector, a natural gas detector, a pressure sensors, an occupancy sensor, a smart home device sensor, any combination thereof, and the like.

The UMN node transceiver 120 includes a receiver component and a transmitter component capable of receiving and transmitting acoustic waveforms on one or more ultrasonic frequencies. In some other embodiments, the UMN node 108 includes a separate receiver and transmitter component. As such, the illustrated transceiver configuration should not be interpreted as being limiting in this manner.

When an object moves around within a “field-of-view” of the UMN node 108, a change in the echo-implied distances can inform the UMN node 108 that something (e.g., a person, animal, or object) is moving nearby. Any information collected by the UMN node transceiver 120 can be “broadcast” and other, similar units, including other UMN nodes 108 and the network interface 110, can receive the broadcast and therefore possess the same information and retransmit the information so that even more nodes may receive the information. The original broadcast could provide a retransmission counter set to zero or some other initial value. A first retransmission could set the value of the retransmission counter to 1, then 2, and so on. The original broadcast also can include a content identifier associated with the information. Each UMN node 108 can receive the content identifier and store, at least temporarily, the content identifier to ascertain whether additional information received from one or more other UMN nodes 108 has already been received, and therefore should be ignored. The content identifier, in some embodiments, is associated with one or more characteristics and/or other output from one or more of the UMN node sensors 118.

By way of example, a first UMN node of the UMN nodes 108 can be configured to broadcast a message that contains the information, a content identifier associated with the information, and a retransmission counter initialized to zero. A second UMN node can receive the broadcast information and can retransmit the information and can increment the counter. The first UMN node can “hear” the second UMN node and can ascertain that the first UMN has already transmitted the information based, for example, upon the content identifier, and therefore does not need to do so again. A third UMN node can receive the broadcast from the second UMN node, increments the retransmission counter, and further retransmits the information. Any UMN node receiving the information will not further retransmit the information because the count would exceed the maximum retransmission setting of two (other maximum retransmission settings can be configured). So long as the network interface 110 receives the information, the network interface 110 can act on the information in a prescribed manner such as by sending the information to one or more of the services 106 via the network 104. The services 106 can utilize the information to perform one or more operations for one or more entities associated with the UMN system 102. The services 106 can include any type of service that is capable of utilizing the information received from the UMN system 102.

Each of the UMN nodes 108 within the UMN system 102 can transmit information on different ultrasonic audio frequencies that can be narrowly spaced because the information content usually requires very little bandwidth. Any UMN node 108 can very rapidly discern all of the members of the UMN system 102 within audio distance, and therefore learns which UMN nodes to which to listen. Each of the UMN nodes 108 can operate in parallel to receive information from multiple other UMN nodes. In some embodiments, inter-node communication can be bi-directional so that new configuration parameters can be uploaded to the different UMN nodes.

In order for a UMN node to measure distances a variety of means are available and are akin to radar technology. For example, a chirped FM waveform can be transmitted and the echo, when electronically mixed with the transmitted waveform, produces a fixed frequency output that is indicative of distance. The offset frequency would be: delta_f=sweep rate (Hz/sec)*distance (m)/speed of sound (m/sec). In this manner, the correlation over time prevents the UMN node transceiver 120 from being fooled by background noise. Many other phase-coded waveforms can be used for measuring distance reliably. The coding mitigates potential measurement corruption from other ultrasonic devices such as bug and rodent repellents.

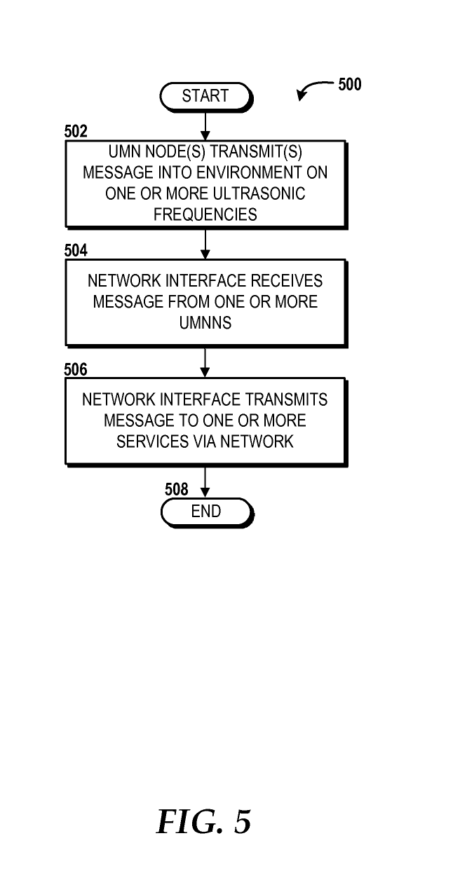

The illustrated network interface 110 includes a network interface processor 122, a network interface memory 124, one or more network interface applications 126, a network interface ultrasonic transceiver 128, a wide area network (“WAN”) transceiver 130, and a local area network transceiver 132. The network interface processor 122 can include one or more processing units configured to process data, execute computer-executable instructions of one or more application programs such as the network interface application(s) 126 stored in the network interface memory 124, and communicate with other components of the network interface 110 in order to perform various operations described herein, such as the operations illustrated and described herein with reference to FIG. 5. The network interface processor 122 may be a standard central processor that performs arithmetic and logical operations, a more specific purpose PLC, a programmable gate array, a system-on-a-chip, or other type of processor known to those skilled in the art and suitable for controlling the operation of the server computer. Processing units are generally known, and therefore the functionality of processing units is not described in further detail herein.

The network interface memory 124 can include, but is not limited to, processor registers, processor cache, RAM, other volatile and non-volatile memory devices, semi-permanent or permanent memory types; for example, tape-based media, optical media, flash media, hard disks, combinations thereof, and the like. While the network interface memory 124 is illustrated as residing proximate to the network interface processor 122, it should be understood that the network interface memory 124 may be a remotely accessed storage system, for example, a server and/or database on a communications network, a remote hard disk drive, a removable storage medium, a database, a server, an optical media writer, combinations thereof, or the like. Memory units are generally known, and therefore the functionality of memory units is not described in further detail herein.

The network interface ultrasonic transceiver 128 includes a receiver component and a transmitter component capable of receiving and transmitting acoustic waveforms on one or more ultrasonic frequencies. In some other embodiments, the network interface 110 includes a separate receiver and transmitter component for receiving and transmitting ultrasonic. As such, the illustrated transceiver configuration should not be interpreted as being limiting in this manner.

The WAN transceiver 130 can facilitate communication between the network interface 110 and one or more wide area networks. The LAN transceiver 132 can facilitate communication between the network interface 110 and one or more local area networks. In some embodiments, the network interface 110 communicates with the network 104 via the WAN transceiver 130 or the LAN transceiver 132. As such, the network 104 may be or may include a wide area network, local area network, or a portion thereof.

Turning now to FIG. 2, an example ultrasonic mesh network 200 will be described, according to an illustrative embodiment. The illustrated ultrasonic mesh network 200 includes a first UMN node 108A, a second UMN node 108B, a third UMN node 108C, a fourth UMN node 108D, a fifth UMN node 108E, the network interface 110, the network 104, and the service(s) 106.

The first UMN node 108A can detect, via one or more UMN node sensors, one or more first environment characteristics 202. The first UMN node 108A can generate a first message that includes the first environment characteristics 202 detected by the first UMN node 108A. The first UMN node 108A can transmit the first message on an ultrasonic frequency via a UMN node transceiver. In the illustrated example, this operation is generally shown as a 0^{th} order 1^{st} message transmission to the second UMN node 108B and to the third UMN node 108C. The second UMN node 108B can receive the first message in the 0^{th} order 1^{st} message transmission from the first UMN node 108A. In response, the second UMN node 108B can increment a first retransmission counter by one and can determine whether the first retransmission counter exceeds a maximum retransmission setting, which can be included with or as part of the first message. If the retransmission counter does not exceed the maximum retransmission setting, the second UMN node 108B can retransmit the first message. If, however, the retransmission counter exceeds the maximum retransmission setting, the second UMN node 108B can determine not to retransmit the first message. In the illustrated example, the retransmission counter does not exceed the maximum retransmission setting, and so the second UMN node 108B can retransmit the first message on an ultrasonic frequency via a UMN node transceiver. This operation is generally shown as a 1^{st} order 1^{st} message retransmission to the fourth UMN node 108D. Although not shown in the illustrated example, the 0^{th} order 1st message transmission may additionally be received by other UMN nodes in other examples.

Similarly, the second UMN node 108B can detect, via one or more UMN node sensors, one or more second environment characteristics 204. The second UMN node 108B can generate a second message that includes the second environment characteristics 204 detected by the second UMN node 108B. The second UMN node 108B can transmit the second message on an ultrasonic frequency via a UMN node transceiver. This operation is generally shown as a 0^{th} order 2^{nd} message transmission to the fourth UMN node 108D. Although not shown in the illustrated example, the 0^{th} order 2^{nd} message transmission may additionally be received by other UMN nodes in other examples.

The second UMN node 108B and third UMN node 108C can receive the first message in the 0^{th} order 1^{st} message transmission from the first UMN node 108A. In response, the second UMN node 108B and third UMN node 108C can each increment a retransmission counter by one and can determine whether the retransmission counter exceeds a maximum retransmission setting, which can be included with or as part of the first message. If the retransmission counter does not exceed the maximum retransmission setting, the second UMN node 108B and/or the third UMN node 108C can retransmit the first message. If, however, the retransmission counter exceeds the maximum retransmission setting, the second UMN node 108B and/or the third UMN node 108C can determine not to retransmit the first message. In the illustrated example, the retransmission counter does not exceed the maximum retransmission setting, and so the second UMN node 108B and the third UMN node 108C can retransmit the first message on an ultrasonic frequency via a UMN node transceiver. This operation is generally shown as a 1^{st} order 1^{st} message retransmission from the second UMN node 108B to the fourth UMN node 108D and to the network interface 110, and from the third UMN node 108C to the fourth UMN node 108D and the fifth UMN node 108E.

The fourth UMN node 108D can receive the first message in the 1^{st} order 1^{st} message retransmission from the second UMN node 108B. In response, the fourth UMN node 108D can increment a retransmission counter by one and can determine whether the retransmission counter exceeds a maximum retransmission setting, which can be included with or as part of the first message. If the retransmission counter does not exceed the maximum retransmission setting, the fourth UMN node 108D can retransmit the first message. If, however, the retransmission counter exceeds the maximum retransmission setting, the fourth UMN node 108D can determine not to retransmit the first message. In the illustrated example, the retransmission counter does not exceed the maximum retransmission setting, and so the fourth UMN node 108D can retransmit the first message on an ultrasonic frequency via a UMN node transceiver. This operation is generally shown as a 2^{nd} order 1^{st} message retransmission from the fourth UMN node 108D to the network interface 110. In the illustrated example, since the network interface 110 has already received the first message from the second UMN node 108B, the network interface 110 can ignore the first message received in the 2^{nd} order 1^{st} message retransmission.

The fourth UMN node 108D also can receive the second message in the 0^{th} order 2^{nd} message transmission. In response, the fourth UMN node 108D can increment a retransmission counter by one and can determine whether the retransmission counter exceeds a maximum retransmission setting, which can be included with or as part of the first message. If the retransmission counter does not exceed the maximum retransmission setting, the fourth UMN node 108D can retransmit the second message. If, however, the retransmission counter exceeds the maximum retransmission setting, the fourth UMN node 108D can determine not to retransmit the second message. In the illustrated example, the retransmission counter does not exceed the maximum retransmission setting, and so the fourth UMN node 108D can retransmit the second message on an ultrasonic frequency via a UMN node transceiver. This operation is generally shown as a 1^{st} order 2^{nd} message retransmission from the fourth UMN node 108D to the network interface 110. In the illustrated example, the network interface 110 has not already received the second message.

The fifth UMN node 108E can receive the first message in the 1^{st} order 1^{st} message retransmission. In response, the fifth UMN node 108E can increment a retransmission counter by one and can determine whether the retransmission counter exceeds a maximum retransmission setting, which can be included with or as part of the first message. If the retransmission counter does not exceed the maximum retransmission setting, the fifth UMN node 108E can retransmit the second message. If, however, the retransmission counter exceeds the maximum retransmission setting, the fifth UMN node 108E can determine not to retransmit the first message. In the illustrated example, the retransmission counter does not exceed the maximum retransmission setting, and so the fifth UMN node 108E can retransmit the first message on an ultrasonic frequency via a UMN node transceiver. This operation is generally shown as a 2^{nd} order 1^{st} message retransmission from the fifth UMN node 108E to the fourth UMN node 108D. In the illustrated example, the fourth UMN node 108D has already received the first message from the second UMN node 108B, and for this reason the fourth UMN node 108D ignores the first message received from the fifth UMN node 108E. In other implementations, the fourth UMN node 108D might determine that the retransmission counter has exceeded the maximum retransmission setting, and for this reason the fourth UMN node 108D ignores the first message received from the fifth UMN node 108E.

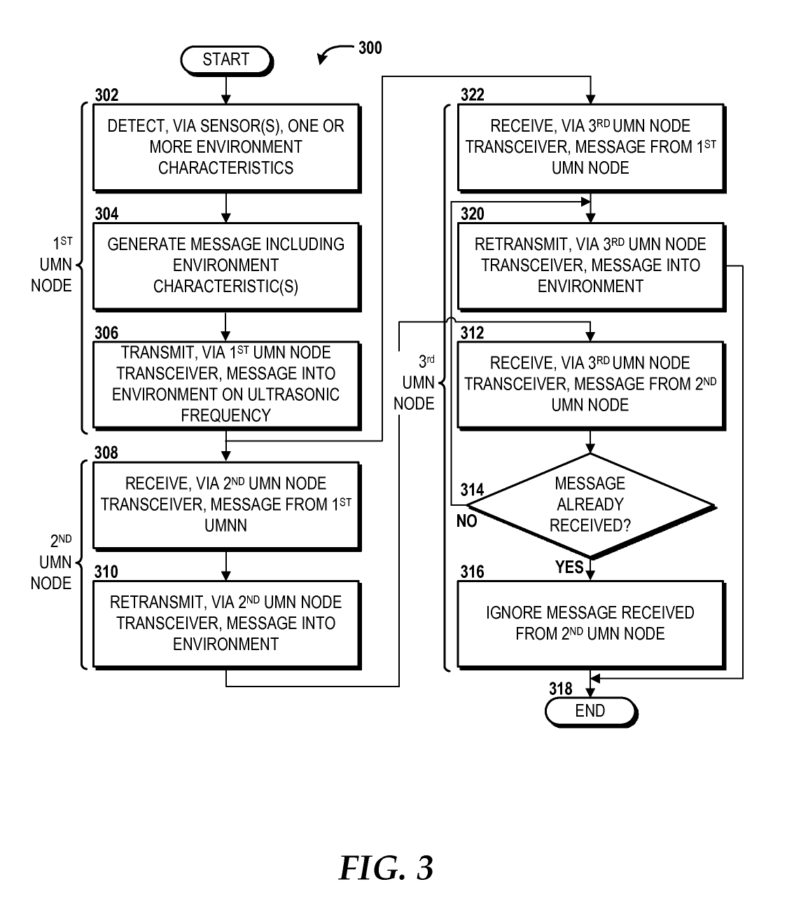

Turning now to FIG. 3, aspects of a method 300 for transmitting a message through the ultrasonic mesh network system 102, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in their respective entireties. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including the UMN nodes 108, the network interface 110, single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof refers to causing a processor of a computing system or device, such as the UMN node processor 112 of the UMN node, the network interface processor 122 of the network interface 110, to perform one or more operations and/or causing the processor to direct other components of the computing system or device to perform one or more of the operations.

For purposes of illustrating and describing some of the concepts of the present disclosure, the methods disclosed herein are described as being performed, at least in part, one or more of the UMN nodes 108, the network interface 110, or a combination thereof, via execution of one or more software modules and/or software applications. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 300 will be described with reference to FIG. 3 and further reference to FIGS. 1-2. The method 300 begins at operation 302, where a first UMN node of the plurality of UMN nodes 108 detects, via the UMN node sensor(s) 118, one or more characteristics of the environment in which the first UMN node is deployed. From operation 302, the method 300 proceeds to operation 304, where the first UMN node generates a message that includes the environment characteristic(s) detected by the UMN node sensor(s) 118 during operation 302. From operation 304, the method 300 proceeds to operation 306, where the first UMN node transmits, via a first UMN node transceiver, the message into the environment on an ultrasonic frequency.

From operation 306, the method 300 proceeds to operation 308, where a second UMN node of the plurality of UMN nodes 108 receives, via a second UMN node transceiver, the message from the first UMN node. From operation 308, the method 300 proceeds to operation 310, where the second UMN node retransmits, via the second UMN node transceiver the message into the environment. In some embodiments, the second UMN node can transmit the message into the environment on the ultrasonic frequency utilized by the first UMN node to transmit the message into the environment. In some other embodiments, the second UMN node can transmit the message into the environment on a different ultrasonic frequency than the ultrasonic frequency utilized by the first UMN node to transmit the message into the environment.

From operation 310, the method 300 proceeds to operation 312, where a third UMN node of the plurality of UMN nodes 108 receives, via a third UMN node transceiver, the message from the second UMN node. From operation 312, the method 300 proceeds to operation 314, where the third UMN node determines whether the message has already been received. If, at operation 314, the third UMN node determines that the message has been received, the method 300 proceeds to operation 316, where the third UMN node ignores the message received from the second UMN node. From operation 316, the method 300 proceeds to operation 318. The method 300 ends at operation 318. If, however, at operation, 314, the third UMN node determines that the message has not been received, the method 300 proceeds to operation 320, where the third UMN node retransmits, via the third UMN node transceiver, the message into the environment. In some embodiments, the third UMN node can transmit the message into the environment on the ultrasonic frequency utilized by the first UMN node and/or the second UMN node to transmit the message into the environment. In some other embodiments, the third UMN node can transmit the message into the environment on a different ultrasonic frequency than the ultrasonic frequency utilized by the first UMN node and/or the second UMN node to transmit the message into the environment. From operation 320, the method 300 proceeds to operation 318. The method 300 ends at operation 318.

Returning to operation 306, the method can proceed to operation 308, as described above, and additionally to operation 322. At operation 322, the third UMN node receives, via the third UMN node transceiver, the message from the first UMN node. It should be understood that any number of other UMN nodes (“N^{th} UMN nodes”) can receive one or more messages deployed by one or more other nodes within the UMN system 102. From operation 322, the method 300 proceeds to operation 320, where the third UMN node retransmits, via the third UMN node transceiver, the message into the environment. In some embodiments, the third UMN node can transmit the message into the environment on the ultrasonic frequency utilized by the first UMN node and/or the second UMN node to transmit the message into the environment. In some other embodiments, the third UMN node can transmit the message into the environment on a different ultrasonic frequency than the ultrasonic frequency utilized by the first UMN node and/or the second UMN node to transmit the message into the environment. From operation 320, the method 300 proceeds to operation 318. The method 300 ends at operation 318.

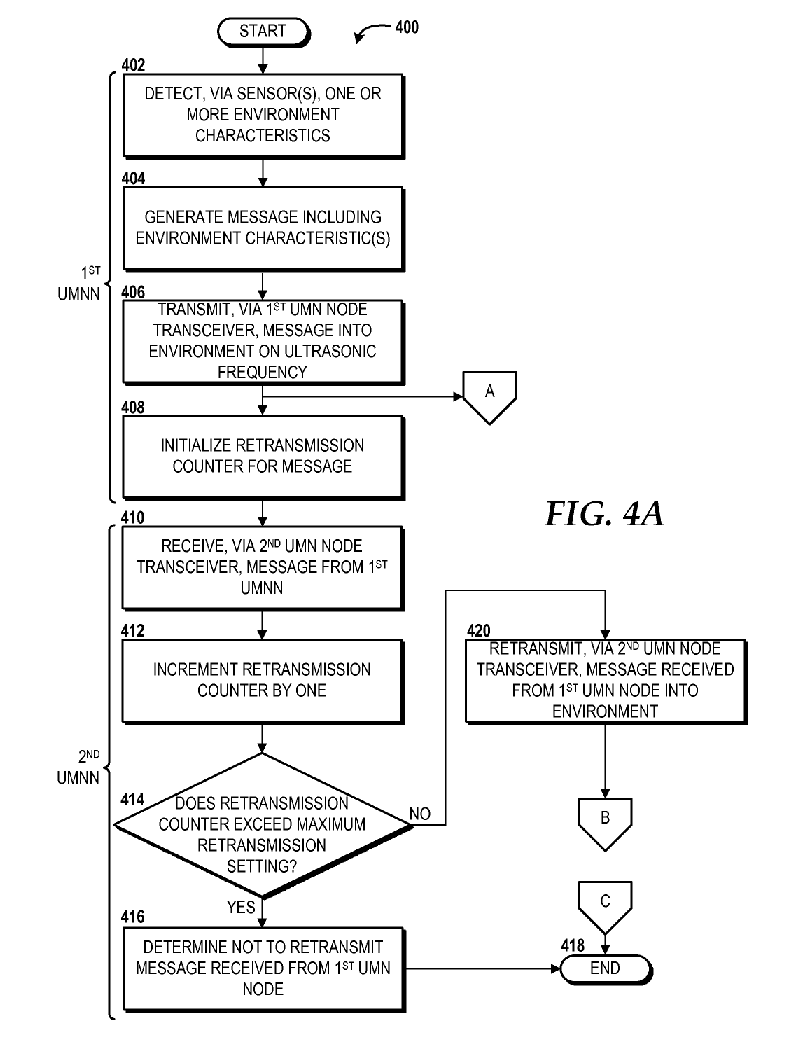

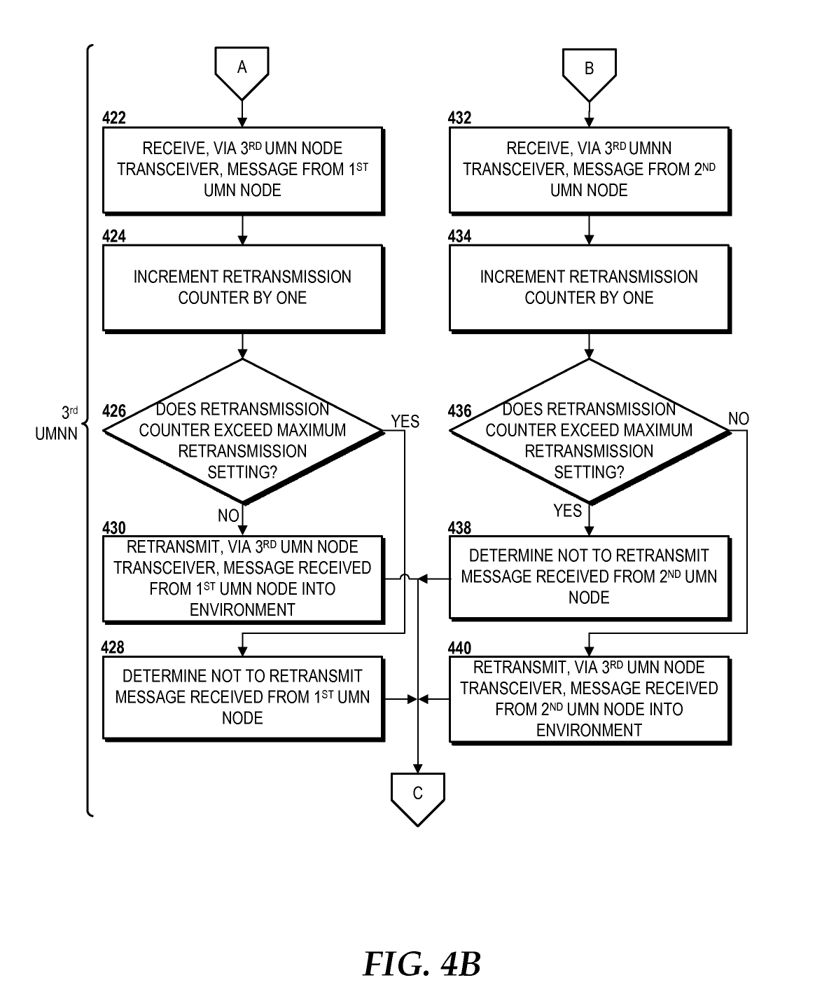

Turning now to FIGS. 4A-4B, another method 400 for transmitting a message through the UMN system 102 will be described, according to an illustrative embodiment. The method 400 begins and proceeds to operation 402, where a first UMN node of the plurality of UMN nodes 108 detects, via the UMN node sensor(s) 118, one or more characteristics of the environment in which the first UMN node is deployed. From operation 402, the method 400 proceeds to operation 404, where the first UMN node generates a message that includes the environment characteristic(s) detected by the UMN node sensor(s) 118 during operation 402. From operation 404, the method 400 proceeds to operation 406, where the first UMN node transmits, via a first UMN node transceiver, the message into the environment on an ultrasonic frequency.

From operation 406, the method 400 proceeds to operation 408, where the first UMN node initializes a retransmission counter for the message. A retransmission counter can be initialized to any value. The retransmission counter can be used to track the number of times the message is retransmitted by any UMN node of the plurality of UMN nodes 108. Each time the message associated with the retransmission counter is to be retransmitted by a UMN node, the UMN node can increment the retransmission counter by one to account for the retransmission. The retransmission counter can be sent along with the message. The retransmission counter can be associated with a maximum retransmission setting.

From operation 408, the method 400 proceeds to operation 410, where a second UMN node of the plurality of UMN nodes 108 receives, via a second UMN node transceiver, the message from the first UMN node. From operation 410, the method 400 proceeds to operation 412, where the second UMN node increments the retransmission counter by one. From operation 412, the method 400 proceeds to operation 414, where the second UMN node determines whether the retransmission counter exceeds a maximum retransmission setting. If, at operation 412, the second UMN node determines that the retransmission counter has exceeded the maximum retransmission setting, the method 400 proceeds to operation 416, where the second UMN node determines not to retransmit the message received from the first UMN node. From operation 416, the method 400 proceeds to operation 418. The method 400 ends at operation 418. If, however, at operation 412, the second UMN node determines that the retransmission counter has not exceeded the maximum retransmission setting, the method 400 proceeds to operation 420. At operation 420, the second UMN node retransmits, via the second UMN node transceiver, the message received from the first UMN node into the environment. In some embodiments, the second UMN node can transmit the message into the environment on the ultrasonic frequency utilized by the first UMN node to transmit the message into the environment. In some other embodiments, the second UMN node can transmit the message into the environment on a different ultrasonic frequency than the ultrasonic frequency utilized by the first UMN node to transmit the message into the environment.

From operation 420, the method 400 proceeds to operation 422 (shown in FIG. 4B). At operation 422, a third UMN node of the plurality of UMN nodes 108 receives, via a third UMN node transceiver, the message from the first UMN node. From operation 422, the method 400 proceeds to operation 424, where the third UMN node increments the retransmission counter by one. From operation 424, the method 400 proceeds to operation 426, where the third UMN node determines whether the retransmission counter exceeds a maximum retransmission setting. If, at operation 426, the second UMN node determines that the retransmission counter has exceeded the maximum retransmission setting, the method 400 proceeds to operation 428, where the second UMN node determines not to retransmit the message received from the first UMN node. From operation 428, the method 400 proceeds to operation 418 (FIG. 4A). The method 400 ends at operation 418. If, however, at operation 426, the second UMN node determines that the retransmission counter has not exceeded the maximum retransmission setting, the method 400 proceeds to operation 430. At operation 430, the third UMN node retransmits, via the third UMN node transceiver, the message received from the first UMN node into the environment. In some embodiments, the third UMN node can transmit the message into the environment on the ultrasonic frequency utilized by the first UMN node to transmit the message into the environment. In some other embodiments, the third UMN node can transmit the message into the environment on a different ultrasonic frequency than the ultrasonic frequency utilized by the first UMN node to transmit the message into the environment. From operation 430, the method 400 proceeds to operation 418 (FIG. 4A). The method 400 ends at operation 418.

Returning to FIG. 4A, and more particularly, to operation 406, the method 400 can proceed to operation 408, as described above, and additionally to operation 432 (FIG. 4B). At operation 432, the third UMN node receives, via the third UMN node transceiver, the message from the second UMN node. It should be understood that any number of other UMN nodes (“N^{th} UMN nodes”) can receive one or more messages one or more other nodes deployed within the UMN system 102. From operation 432, the method 400 proceeds to operation 434, where the third UMN node increments the retransmission counter by one. From operation 434, the method 400 proceeds to operation 436, where the third UMN node determines whether the retransmission counter exceeds a maximum retransmission setting. If, at operation 436, the third UMN node determines that the retransmission counter has exceeded the maximum retransmission setting, the method 400 proceeds to operation 438, where the third UMN node determines not to retransmit the message received from the second UMN node. From operation 438, the method 400 proceeds to operation 418 (FIG. 4A). The method 400 ends at operation 418. If, however, at operation 436, the third UMN node determines that the retransmission counter has not exceeded the maximum retransmission setting, the method 400 proceeds to operation 430. At operation 430, the third UMN node retransmits, via the third UMN node transceiver, the message received from the second UMN node into the environment. In some embodiments, the third UMN node can transmit the message into the environment on the ultrasonic frequency utilized by the second UMN node to transmit the message into the environment. In some other embodiments, the third UMN node can transmit the message into the environment on a different ultrasonic frequency than the ultrasonic frequency utilized by the second UMN node to transmit the message into the environment. From operation 430, the method 400 proceeds to operation 418 (FIG. 4A). The method 400 ends at operation 418.

Turning now to FIG. 5, a flow diagram illustrating aspects of a method 500 for transmitting a message through the ultrasonic mesh network system 102 to a network interface will be described, according to an illustrative embodiment. The method 500 begins and proceeds to operation 502, where one or more UMN nodes 108 transmits one or more messages into the environment on one or more ultrasonic frequencies. The operation 502 can include an initial transmission and one or more retransmissions of the message(s) into the environment. From operation 502, the method 500 proceeds to operation 504, where the network interface 110 receives the message(s) from one or more of the UMN nodes 108. From operation 504, the method 500 proceeds to operation 506, where the network interface 110 transmits the message(s) to one or more of the services 106 via the network 104. From operation 506, the method 500 proceeds to operation 508. The method 500 ends at operation 508.

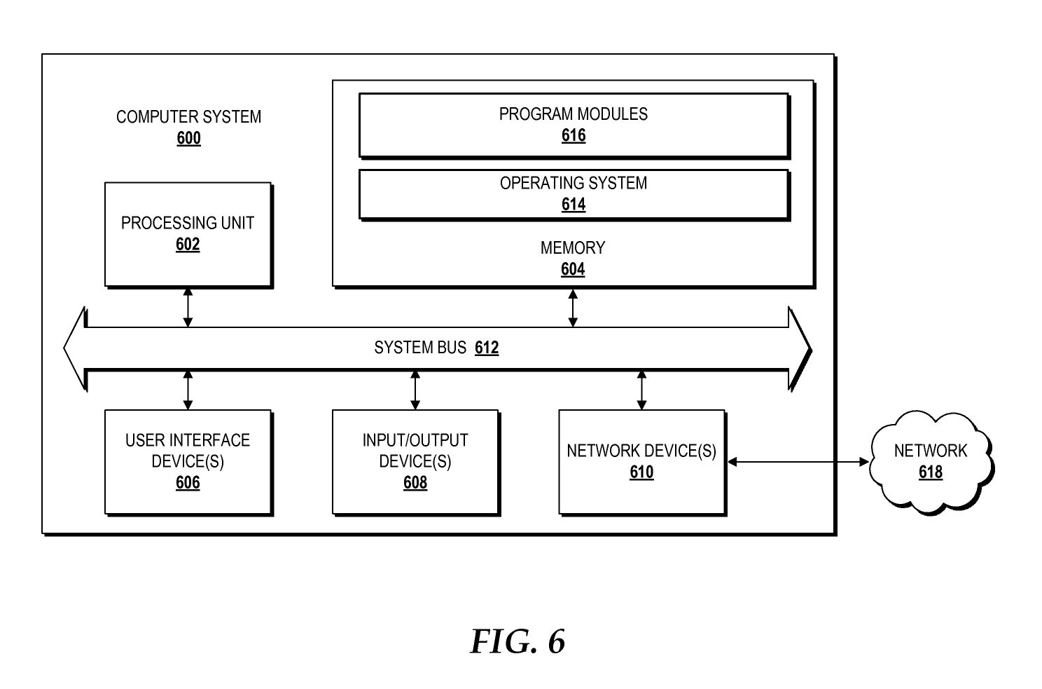

FIG. 6 is a block diagram illustrating a computer system 600 configured to provide the functionality in accordance with various embodiments of the concepts and technologies disclosed herein. In some implementations, one or more of the UMN nodes 108, the network interface 110, or some combination thereof utilize an architecture that is the same as or similar to the architecture of the computer system 600. It should be understood, however, that modification to the architecture may be made to facilitate certain interactions among elements described herein.

The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, a system-on-a-chip, or other type of processor known to those skilled in the art and suitable for controlling the operation of the server computer. Processing units are generally known, and therefore are not described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 616 may include various software and/or program modules to perform the various operations described herein. The program modules 616 for the computer system 600 embodied as a UMN node 108 can include the UMN node application(s) 116. The program modules 616 for the computer system 600 embodied as the network interface 110 can include the network interface application(s) 126. The program modules 616 and/or other programs can be embodied in computer-readable media containing instructions that, when executed by the processing unit 602, perform one or more operations, such as the operations described herein above with reference to the methods 300, 400, 500 illustrated, respectively, in FIGS. 3, 4, and 5. According to embodiments, the program modules 616 may be embodied in hardware, software, firmware, or any combination thereof.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network 618, such as the network 104 (shown in FIGS. 1 and 2). Examples of the network devices 610 include, but are not limited to, a modem, a radio frequency (“RF”) or infrared (“IR”) transceiver, a telephonic interface, a bridge, a router, or a network card. The network 618 may include a wireless network such as, but not limited to, a wireless local area network (“WLAN”), a wireless wide area network (“WWAN”), a wireless personal area network (“WPAN”) such as provided via BLUETOOTH technology, a wireless metropolitan area network (“WMAN”) such as a WiMAX network or metropolitan cellular network. Alternatively, the network 618 may be a wired network such as, but not limited to, a wide area network (“WAN”), a wired LAN such as provided via Ethernet, a wired personal area network n (“PAN”), or a wired metropolitan area network (“MAN”).

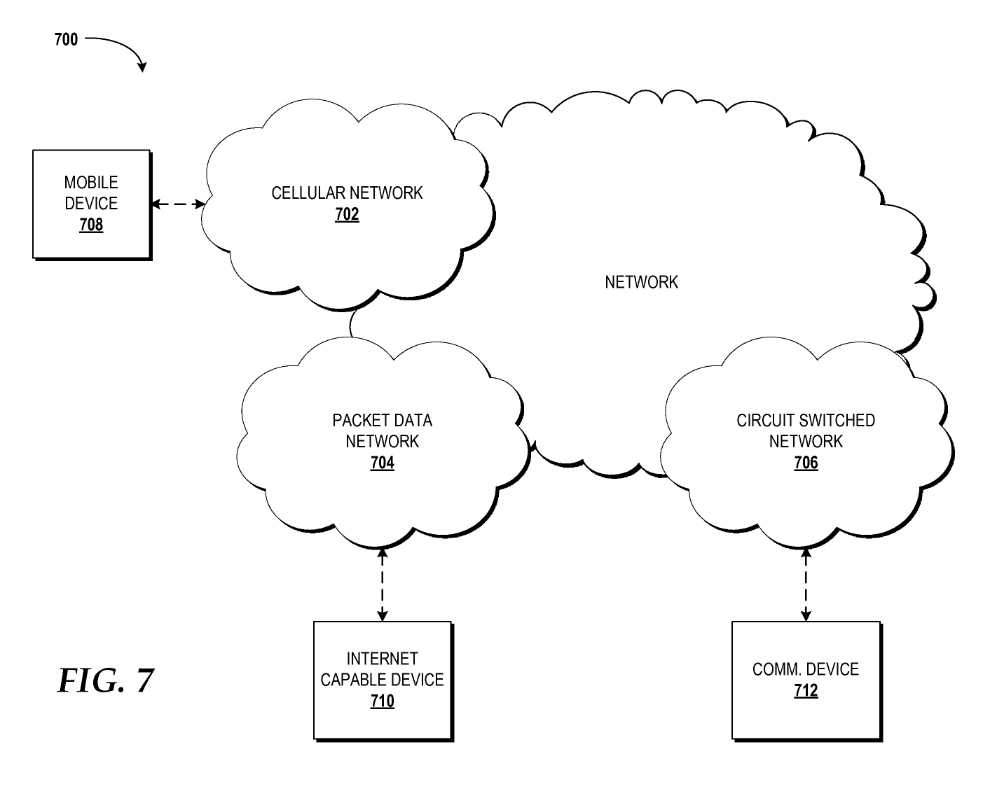

Turning now to FIG. 7, additional details of a network 700, such as the network 104, are illustrated, according to an illustrative embodiment. The network 700 includes a cellular network 702, a packet data network 704, for example, the Internet, and a circuit switched network 706, for example, a publicly switched telephone network (“PSTN”). The cellular network 702 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 702 also includes radios and nodes for receiving and transmitting voice, data, and combinations thereof to and from radio transceivers, networks, the packet data network 704, and the circuit switched network 706.

A mobile communications device 708, such as, for example, a cellular telephone, a user equipment, a mobile terminal, a PDA, a laptop computer, a handheld computer, and combinations thereof, can be operatively connected to a cellular network. In some embodiments, the UMN node(s) 108, the network interface 110, or some combination thereof can be embodied as the mobile communication device 708. The cellular network 702 can be configured as a 2G Global System for Mobile communications (“GSM”) network and can provide data communications via General Packet Radio Service (“GPRS”) and/or Enhanced Data rates for GSM Evolution (“EDGE”). Additionally, or alternatively, the cellular network 702 can be configured as a 3G Universal Mobile Telecommunications System (“UMTS”) network and can provide data communications via the High-Speed Packet Access (“HSPA”) protocol family, for example, High-Speed Downlink Packet Access (“HSDPA”), Enhanced UpLink (“EUL”) (also referred to as High-Speed Uplink Packet Access (“HSUPA”)), and HSPA+. The cellular network 702 also is compatible with 4G mobile communications standards such as Long-Term Evolution (“LTE”), or the like, as well as evolved and future mobile standards.

The packet data network 704 includes various devices, for example, servers, computers, databases, and other devices in communication with another, as is generally known. The packet data network 704 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 704 includes or is in communication with the Internet. The circuit switched network 706 includes various hardware and software for providing circuit switched communications. The circuit switched network 706 may include, or may be, what is often referred to as a plain old telephone system (“POTS”). The functionality of a circuit switched network 706 or other circuit-switched network are generally known and will not be described herein in detail.

The illustrated cellular network 702 is shown in communication with the packet data network 704 and a circuit switched network 706, though it should be appreciated that this is not necessarily the case. One or more Internet-capable devices 710, for example, a PC, a laptop, a portable device, or another suitable device, can communicate with one or more cellular networks 702, and devices connected thereto, through the packet data network 704. In some embodiments, the UMN node(s) 108, the network interface 110, or some combination thereof can be embodied as the Internet-capable device 710. It also should be appreciated that the Internet-capable device 710 can communicate with a packet data network through the circuit switched network 706, the cellular network 702, and/or via other networks (not illustrated).

As illustrated, a communications device 712, for example, a telephone, facsimile machine, modem, computer, or the like, can be in communication with the circuit switched network 706, and therethrough to the packet data network 704 and/or the cellular network 702. In some embodiments, the UMN node(s) 108, the network interface 110, or some combination thereof can be embodied as the communication device 712.

It should be appreciated that the communications device 712 can be an Internet-capable device, and can be substantially similar to the Internet-capable device 710. In the specification, the network 700 is used to refer broadly to any combination of the networks 702, 704, 706. It should be appreciated that substantially all of the functionality described with reference to the network 700 can be performed by the cellular network 702, the packet data network 704, and/or the circuit switched network 706, alone or in combination with other networks, network elements, and the like.

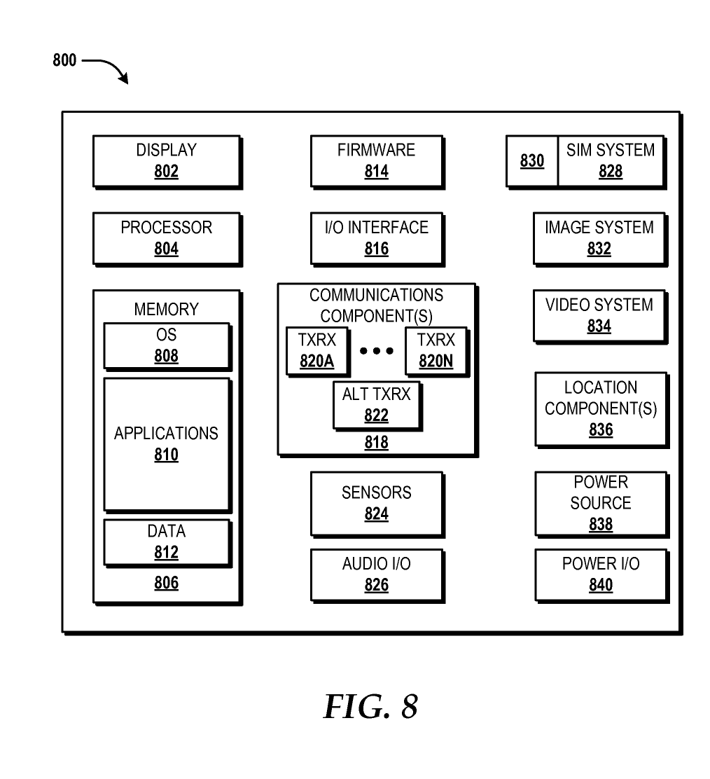

Turning now to FIG. 8, an illustrative mobile device 800 and components thereof will be described. In some embodiments, the UMN node(s) 108, the network interface 110, or some combination thereof can be configured as and/or can have an architecture similar or identical to the mobile device 800 described herein in FIG. 8. It should be understood, however, that the UMN node(s) 108 and/or the network interface 110 may or may not include the functionality described herein with reference to FIG. 8. While connections are not shown between the various components illustrated in FIG. 8, it should be understood that some, none, or all of the components illustrated in FIG. 8 can be configured to interact with one other to carry out various device functions. In some embodiments, the components are arranged so as to communicate via one or more busses (not shown). Thus, it should be understood that FIG. 8 and the following description are intended to provide a general understanding of a suitable environment in which various aspects of embodiments can be implemented, and should not be construed as being limiting in any way.

As illustrated in FIG. 8, the mobile device 800 can include a display 802 for displaying data. According to various embodiments, the display 802 can be configured to display various graphical user interface (“GUI”) elements, text, images, video, advertisements, prompts, virtual keypads and/or keyboards, messaging data, notification messages, metadata, internet content, device status, time, date, calendar data, device preferences, map and location data, combinations thereof, and the like. The mobile device 800 also can include a processor 804 and a memory or other data storage device (“memory”) 806. The processor 804 can be configured to process data and/or can execute computer-executable instructions stored in the memory 806. The computer-executable instructions executed by the processor 804 can include, for example, an operating system 808, one or more applications 810 (e.g., the UMN node application(s) 116 and/or the network interface application(s) 126), other computer-executable instructions stored in a memory 806, or the like. In some embodiments, the applications 810 also can include a UI application (not illustrated in FIG. 8).

The UI application can interface with the operating system 808 to facilitate user interaction with functionality and/or data stored at the mobile device 800 and/or stored elsewhere. In some embodiments, the operating system 808 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 804 to aid a user in entering content, viewing account information, answering/initiating calls, entering/deleting data, entering and setting user IDs and passwords for device access, configuring settings, manipulating address book content and/or settings, multimode interaction, interacting with other applications 810, and otherwise facilitating user interaction with the operating system 808, the applications 810, and/or other types or instances of data 812 that can be stored at the mobile device 800.

According to various embodiments, the applications 810 can include, for example, the UMN node application(s) 116 and/or the network interface application(s) 126, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 810, the data 812, and/or portions thereof can be stored in the memory 806 and/or in a firmware 814, and can be executed by the processor 804. The firmware 814 also can store code for execution during device power up and power down operations. It can be appreciated that the firmware 814 can be stored in a volatile or non-volatile data storage device including, but not limited to, the memory 806 and/or a portion thereof.

The mobile device 800 also can include an input/output (“I/O”) interface 816. The I/O interfaced 816 can be configured to support the input/output of data such as location information, user information, organization information, presence status information, user IDs, passwords, and application initiation (start-up) requests. In some embodiments, the I/O interface 816 can include a hardwire connection such as USB port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 800 can be configured to synchronize with another device to transfer content to and/or from the mobile device 800. In some embodiments, the mobile device 800 can be configured to receive updates to one or more of the applications 810 via the I/O interface 816, though this is not necessarily the case. In some embodiments, the I/O interface 816 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 816 may be used for communications between the mobile device 800 and a network device or local device.

The mobile device 800 also can include a communications component 818. The communications component 818 can be configured to interface with the processor 804 to facilitate wired and/or wireless communications with one or more networks, such as the network 104 described above herein. In some embodiments, other networks include networks that utilize non-cellular wireless technologies such as WI-FI or WIMAX. In some embodiments, the communications component 818 includes a multimode communications subsystem for facilitating communications via the cellular network and one or more other networks.

The communications component 818, in some embodiments, includes one or more transceivers. The one or more transceivers, if included, can be configured to communicate over the same and/or different wireless technology standards with respect to one another. For example, in some embodiments one or more of the transceivers of the communications component 818 may be configured to communicate using GSM, CDMA, CDMAONE, CDMA2000, LTE, and various other 2G, 2.5G, 3G, 4G, and greater generation technology standards. Moreover, the communications component 818 may facilitate communications over various channel access methods (which may or may not be used by the aforementioned standards) including, but not limited to, TDMA, FDMA, W-CDMA, OFDM, SDMA, and the like.

In addition, the communications component 818 may facilitate data communications using GPRS, EDGE, the HSPA protocol family, including HSDPA, EUL, or otherwise termed HSUPA, HSPA+, and various other current and future wireless data access standards. In the illustrated embodiment, the communications component 818 can include a first transceiver (“TxRx”) 820A that can operate in a first communications mode (e.g., GSM). The communications component 818 also can include an N^{th} transceiver (“TxRx”) 820N that can operate in a second communications mode relative to the first transceiver 820A (e.g., UMTS). While two transceivers 820A-N (hereinafter collectively and/or generically referred to as “transceivers 820”) are shown in FIG. 8, it should be appreciated that less than two, two, and/or more than two transceivers 820 can be included in the communications component 818.

The communications component 818 also can include an alternative transceiver (“Alt TxRx”) 822 for supporting other types and/or standards of communications. According to various contemplated embodiments, the alternative transceiver 822 can communicate using various communications technologies such as, for example, WI-FI, WIMAX, BLUETOOTH, infrared, infrared data association (“IRDA”), near-field communications (“NFC”), other radio frequency (“RF”) technologies, combinations thereof, and the like.

In some embodiments, the communications component 818 also can facilitate reception from terrestrial radio networks, digital satellite radio networks, internet-based radio service networks, combinations thereof, and the like. The communications component 818 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 800 also can include one or more sensors 824. The sensors 824 can include temperature sensors, light sensors, air quality sensors, movement sensors, orientation sensors, noise sensors, proximity sensors, the UMN node sensor(s) 108, or the like. As such, it should be understood that the sensors 824 can include, but are not limited to, accelerometers, magnetometers, gyroscopes, infrared sensors, noise sensors, microphones, combinations thereof, or the like. Additionally, audio capabilities for the mobile device 800 may be provided by an audio I/O component 826. The audio I/O component 826 of the mobile device 800 can include one or more speakers for the output of audio signals, one or more microphones for the collection and/or input of audio signals, and/or other audio input and/or output devices.

The illustrated mobile device 800 also can include a subscriber identity module (“SIM”) system 828. The SIM system 828 can include a universal SIM (“USIM”), a universal integrated circuit card (“UICC”) and/or other identity devices. The SIM system 828 can include and/or can be connected to or inserted into an interface such as a slot interface 830. In some embodiments, the slot interface 830 can be configured to accept insertion of other identity cards or modules for accessing various types of networks. Additionally, or alternatively, the slot interface 830 can be configured to accept multiple subscriber identity cards. Because other devices and/or modules for identifying users and/or the mobile device 800 are contemplated, it should be understood that these embodiments are illustrative, and should not be construed as being limiting in any way.

The mobile device 800 also can include an image capture and processing system 832 (“image system”). The image system 832 can be configured to capture or otherwise obtain photos, videos, and/or other visual information. As such, the image system 832 can include cameras, lenses, charge-coupled devices (“CCDs”), combinations thereof, or the like. The mobile device 800 may also include a video system 834. The video system 834 can be configured to capture, process, record, modify, and/or store video content. Photos and videos obtained using the image system 832 and the video system 834, respectively, may be added as message content to a multimedia message service (“MMS”) message, email message, and sent to another mobile device. The video and/or photo content also can be shared with other devices via various types of data transfers via wired and/or wireless communication devices as described herein.

The mobile device 800 also can include one or more location components 836. The location components 836 can be configured to send and/or receive signals to determine a geographic location of the mobile device 800. According to various embodiments, the location components 836 can send and/or receive signals from GPS devices, A-GPS devices, WI-FI/WIMAX and/or cellular network triangulation data, combinations thereof, and the like. The location component 836 also can be configured to communicate with the communications component 818 to retrieve triangulation data for determining a location of the mobile device 800. In some embodiments, the location component 836 can interface with cellular network nodes, telephone lines, satellites, location transmitters and/or beacons, wireless network transmitters and receivers, combinations thereof, and the like. In some embodiments, the location component 836 can include and/or can communicate with one or more of the sensors 824 such as a compass, an accelerometer, and/or a gyroscope to determine the orientation of the mobile device 800. Using the location component 836, the mobile device 800 can generate and/or receive data to identify its geographic location, or to transmit data used by other devices to determine the location of the mobile device 800. The location component 836 may include multiple components for determining the location and/or orientation of the mobile device 800.

The illustrated mobile device 800 also can include a power source 838. The power source 838 can include one or more batteries, power supplies, power cells, and/or other power subsystems including alternating current (“AC”) and/or direct current (“DC”) power devices. The power source 838 also can interface with an external power system or charging equipment via a power I/O component 840. Because the mobile device 800 can include additional and/or alternative components, the above embodiment should be understood as being illustrative of one possible operating environment for various embodiments of the concepts and technologies described herein. The described embodiment of the mobile device 800 is illustrative, and should not be construed as being limiting in any way.

Based on the foregoing, it should be appreciated that concepts and technologies directed to an ultrasonic mesh network system have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

We claim:

1. An ultrasonic mesh network system, comprising:
a plurality of nodes deployed within an environment, the plurality of nodes comprising
a first node comprising a first processor, a first memory, a first ultrasonic transceiver, and a sensor, and
a second node comprising a second processor, a second memory, and a second ultrasonic transceiver;
wherein the first memory of the first node stores first instructions that, when executed by the first processor of the first node, cause the first node to perform first operations comprising
detecting, via the sensor, a characteristic of the environment,
generating a message comprising the characteristic of the environment, and
transmitting, via the first ultrasonic transceiver, the message into the environment on an ultrasonic frequency; and
wherein the second memory of the second node stores second instructions that, when executed by the second processor of the second node, cause the second node to perform second operations comprising
receiving, via the second ultrasonic transceiver, the message from the first ultrasonic transceiver on the ultrasonic frequency, and
retransmitting, via the second ultrasonic transceiver, the message received from the first ultrasonic transceiver.

2. The ultrasonic mesh network system of claim 1, wherein the plurality of nodes further comprises a third node comprising a third processor, a third memory, and a third ultrasonic transceiver, and wherein the third memory of the third node stores third instructions that, when executed by the third processor of the third node, cause the third node to perform third operations comprising:
receiving, via the third ultrasonic transceiver, the message from the first ultrasonic transceiver on the ultrasonic frequency;
retransmitting, via the third ultrasonic transceiver, the message received from the first ultrasonic transceiver on the ultrasonic frequency;
receiving, via the third ultrasonic transceiver, the message from the second ultrasonic transceiver;
in response to receiving the message from the second ultrasonic transceiver,
determining that the message was already received from the first ultrasonic transceiver; and
ignoring the message received from the second ultrasonic transceiver.

3. The ultrasonic mesh network system of claim 2, wherein the message further comprises a content identifier that identifies the characteristic of the environment, and wherein determining that the message was already received from the first ultrasonic transceiver comprises determining, based upon the content identifier, that the message was already received from the first ultrasonic transceiver.

4. The ultrasonic mesh network system of claim 1, wherein:
the first operations further comprise initializing a retransmission counter;
the second operations further comprise, prior to retransmitting the message received from the first ultrasonic transceiver, incrementing the retransmission counter by one, and determining that the retransmission counter does not exceed a maximum retransmission setting; and
the plurality of nodes further comprises a third node comprising a third ultrasonic transceiver, and wherein the third node performs third operations comprising receiving, via the third ultrasonic transceiver, the message from the first ultrasonic transceiver on the ultrasonic frequency, incrementing the retransmission counter by one, determining that the retransmission counter meets the maximum retransmission setting, retransmitting, via the third ultrasonic transceiver, the message received from the first ultrasonic transceiver, receiving, via the third ultrasonic transceiver, the message from the second ultrasonic transceiver, incrementing the retransmission counter by one, determining that the retransmission counter exceeds the maximum retransmission setting, and in response to the retransmission counter exceeding the maximum retransmission setting, determining not to retransmit the message received from the second ultrasonic transceiver.

5. The ultrasonic mesh network system of claim 1, further comprising a network interface, and wherein the network interface performs third operations comprising:
receiving, via at least the first ultrasonic transceiver or at least the second ultrasonic transceiver, the message; and
transmitting the message to a network.

6. The ultrasonic mesh network system of claim 1, wherein retransmitting, via the second ultrasonic transceiver, the message received from the first ultrasonic transceiver comprises retransmitting, via the second ultrasonic transceiver, the message received from the first ultrasonic transceiver on a different ultrasonic frequency than the ultrasonic frequency.

7. The ultrasonic mesh network system of claim 1, wherein the first node and the second node are Internet of things devices.

8. An ultrasonic mesh network node deployed within an environment comprising a plurality of ultrasonic mesh network nodes, the ultrasonic mesh network node comprising:
a sensor;
an ultrasonic transceiver;
a processor; and
a memory that stores instructions that, when executed by the processor, causes the processor to perform operations comprising
causing the sensor to detect a characteristic of the environment;
generating a message comprising the characteristic of the environment; and
causing the ultrasonic transceiver to transmit the message into the environment on an ultrasonic frequency.

9. The ultrasonic mesh network node of claim 8, wherein the operations further comprise:
receiving the message from a further ultrasonic mesh network node of the plurality of ultrasonic mesh network nodes;
determining that the message received from the further ultrasonic mesh network node is the same as the message that the ultrasonic transceiver transmitted into the environment; and
in response to determining that the message received from the further ultrasonic mesh network node is the same as the message that the ultrasonic transceiver transmitted into the environment, ignoring the message received from the further ultrasonic mesh network node.

10. The ultrasonic mesh network node of claim 9, wherein the message further comprises a content identifier that identifies the characteristic of the environment, and wherein determining that the message received from the further ultrasonic mesh network node is the same as the message that the ultrasonic transceiver transmitted into the environment comprises determining that the message received from the further ultrasonic mesh network node is the same as the message that the ultrasonic transceiver transmitted into the environment based upon the content identifier.

11. The ultrasonic mesh network node of claim 8, wherein the operations further comprise:
receiving a further message from a further ultrasonic mesh network node of the plurality of ultrasonic mesh network nodes;
incrementing a retransmission counter by one in response to receiving the further message;
determining that the retransmission counter does not exceed a maximum retransmission setting; and
retransmitting the further message into the environment.

12. The ultrasonic mesh network node of claim 8, wherein the operations further comprise:
receiving a further message from a further ultrasonic mesh network node of the plurality of ultrasonic mesh network nodes;
incrementing a retransmission counter by one in response to receiving the further message;
determining that the retransmission counter exceeds a maximum retransmission setting; and
determining not to retransmit the further message into the environment.

13. The ultrasonic mesh network node of claim 8, wherein causing the ultrasonic transceiver to transmit the message into the environment comprising causing the ultrasonic transceiver to transmit the message to a network interface that transmits the message on to a network.

14. The ultrasonic mesh network node of claim 8, wherein the operations further comprise:
receiving a further message from a further ultrasonic mesh network node of the plurality of ultrasonic mesh network nodes on a first ultrasonic frequency; and
retransmitting the further message into the environment on a second ultrasonic frequency.

15. A method, comprising:
detecting, via a sensor of a first node of an ultrasonic mesh network system, a characteristic of an environment in which a plurality of nodes are deployed;
generating, by the first node, a message comprising the characteristic of the environment;
transmitting, via a first ultrasonic transceiver of the first node, the message into the environment on an ultrasonic frequency;
receiving, via a second ultrasonic transceiver of a second node of the ultrasonic mesh network system, the message from the first ultrasonic transceiver on the ultrasonic frequency; and
retransmitting, via the second ultrasonic transceiver of the second node, the message received from the first ultrasonic transceiver.

16. The method of claim 15, further comprising:
receiving, via a third ultrasonic transceiver of a third node of the ultrasonic mesh network system, the message from the first ultrasonic transceiver on the ultrasonic frequency;
retransmitting, via the third ultrasonic transceiver, the message received from the first ultrasonic transceiver on the ultrasonic frequency;
receiving, via the third ultrasonic transceiver, the message from the second ultrasonic transceiver;
in response to receiving, via the third node, the message from the second ultrasonic transceiver,
determining, via the third node, that the message was already received from the first ultrasonic transceiver; and
ignoring, via the third node, the message received from the second ultrasonic transceiver.

17. The method of claim 16, wherein the message further comprises a content identifier that identifies the characteristic of the environment, and wherein determining, via the third node, that the message was already received from the first ultrasonic transceiver comprises determining, via the third node, based upon the content identifier, that the message was already received from the first ultrasonic transceiver.

18. The method of claim 15, further comprising:
initializing, by the first node, a retransmission counter;
prior to retransmitting the message received, via the second ultrasonic transceiver of the second node from the first ultrasonic transceiver of the first node,
incrementing, by the second node, the retransmission counter by one, and
determining, by the second node, that the retransmission counter does not exceed a maximum retransmission setting;
receiving, via a third ultrasonic transceiver of a third node of the ultrasonic mesh network system, the message from the first ultrasonic transceiver on the ultrasonic frequency;
incrementing, via the third node, the retransmission counter by one;
determining, via the third node, that the retransmission counter meets the maximum retransmission setting;
retransmitting, via the third ultrasonic transceiver of the third node, the message received from the first ultrasonic transceiver;
receiving, via the third ultrasonic transceiver of the third node, the message from the second ultrasonic transceiver;
incrementing, via the third node, the retransmission counter by one;
determining, via the third node, that the retransmission counter exceeds the maximum retransmission setting; and
in response to the retransmission counter exceeding the maximum retransmission setting, determining, via the third node, not to retransmit the message received from the second ultrasonic transceiver.

19. The method of claim 15, further comprising:
receiving, via a network interface, the message from at least the first ultrasonic transceiver or at least the second ultrasonic transceiver; and
transmitting, via the network interface, the message to a network.

20. The method of claim 15, wherein retransmitting, via the second ultrasonic transceiver of the second node, the message received from the first ultrasonic transceiver comprises retransmitting, via the second ultrasonic transceiver, the message received from the first ultrasonic transceiver on a different ultrasonic frequency than the ultrasonic frequency.
